(19) United States
(12) Patent Application Publication
(10) Pub. No.: US 2026/0360865 A1
(43) Pub. Date: Nov. 12, 2026

(54) FIRE RESISTANT ASSEMBLY AND BATTERY ASSEMBLY INCLUDING THE SAME

(71) Applicant: SK On Co., Ltd., Seoul (KR)

(72) Inventor: Hui Jun SHIN, Daejeon (KR)

(21) Appl. No.: 19/670,029

(22) Filed: May 7, 2026

(30) Foreign Application Priority Data
May 7, 2025 (KR) 10-2025-0058973

(51) Int. Cl. H01M 10/658; H01M 10/6555; H01M 50/505

(52) U.S. Cl. CPC H01M 10/658; H01M 10/6555; H01M 50/505

(57) ABSTRACT

The present disclosure relates to a fire-resistant assembly. The fire-resistant assembly may include a fire-resistant portion including first material that is fire resistant, and a support structure embedded inside the fire-resistant portion. According to an embodiment of the present disclosure, thermal propagation during thermal runaway of a battery cell can be suppressed, thereby the stability of a battery assembly can be enhanced.

### CROSS-REFERENCE TO RELATED APPLICATIONS

The present application claims priority under 35 U.S.C. § 119(a) to Korean patent application number 10-2025-0058973, filed on May 7, 2025, in the Ministry of Intellectual Property, the entire disclosure of which is incorporated herein by reference.

### BACKGROUND

### 1. Technical Field

The present disclosure relates to a fire-resistant assembly capable of improving the quality of a secondary battery module, and a battery assembly including the same.

### 2. Related Art

As the price of energy sources increases due to the depletion of fossil fuels and the concerns about environmental pollution are growing, the demand for eco-friendly alternative energy sources is becoming an indispensable factor for future living. In particular, as the technological development and demand for mobile devices increases, the demand for secondary batteries as energy sources is rapidly increasing. Recently, due to fire and explosion incidents occurring during the use of secondary batteries, social concerns about the safety of battery use have been increasing. Based on such social concerns, one of the major development challenges of secondary batteries is to eliminate instability, such as fire or explosion, caused by thermal runaway of battery cells.

For example, in a secondary battery module or pack, empty spaces exist other than the battery cells serving as energy sources. When a fire occurs due to external impact or a problem with a battery cell, flames may propagate to adjacent cells through the empty spaces, thereby increasing the damage caused by the fire. Since the risk of such fire can be one of the biggest obstacles to the electric vehicle market, the significance of research on methods or structures capable of blocking or delaying the propagation of fire is increasing.

Accordingly, since fire or explosion and ignition caused by thermal runaway of a battery cell degrade the durability and safety of not only the secondary battery module or pack but also the entire electric vehicle, there is a need for developing a fire-resistant assembly capable of preventing thermal propagation and ignition within the battery module or pack, and a battery assembly including the same.

### SUMMARY

According to an aspect of the present disclosure, a technical problem is to prevent, mitigate or delay high-temperature gas or flames from escaping in the direction of lead tabs or a tab direction of a battery cell where thermal runaway has occurred, in battery cells accommodated inside a secondary battery assembly, for example, a secondary battery module or pack.

According to another aspect of the present disclosure, a technical problem is to enhance the stability of a secondary battery assembly by increasing the heat resistance or fire resistance of a fire-resistant assembly that can be included in the battery assembly during assembly of the secondary battery assembly.

According to yet another aspect of the present disclosure, a technical problem is to insert a fire-resistant assembly into a space formed between a busbar assembly and a plurality of battery cells, while minimizing changes to an existing assembly process of the battery assembly.

According to yet another aspect of the present disclosure, a technical problem is to provide a method capable of easily implementing the arrangement of a fire-resistant assembly that can be included in a battery assembly during assembly of the secondary battery assembly.

Meanwhile, the fire-resistant assembly according to the present disclosure can be widely applied in the fields of green technology, such as electric vehicles, battery charging stations, energy storage systems (ESS), and photovoltaics and wind power using battery cells.

Additionally, the fire-resistant assembly according to the present disclosure can be used in eco-friendly mobility including electric vehicles and hybrid vehicles for preventing climate change by suppressing air pollution and greenhouse gas emissions.

The present disclosure provides a fire-resistant assembly, which may include: a fire-resistant portion including first material that is fire-resistant; and a support structure embedded inside the fire-resistant portion.

In an embodiment of the present disclosure, the support structure may include a first plate and a second plate.

In an embodiment of the present disclosure, the first plate and the second plate may intersect with each other.

In an embodiment of the present disclosure, the first plate may include a first slit in which a first opening is formed in a longitudinal direction of the support structure, and a first fixed end at which the first opening terminates, and the second plate may include a second slit in which a second opening is formed in the longitudinal direction of the support structure, and a second fixed end at which the second opening terminates.

In an embodiment of the present disclosure, the support structure may include an intersection portion formed by the first plate and the second plate intersecting with each other by inserting the first slit and the second slit into each other in the longitudinal direction.

In an embodiment of the present disclosure, the first fixed end and the second fixed end may be in contact with each other.

In an embodiment of the present disclosure, the support structure may include a first intersection angle and a second intersection angle formed by the first plate and the second plate intersecting with each other.

In an embodiment of the present disclosure, the first intersection angle may be smaller than or equal to the second intersection angle.

In an embodiment of the present disclosure, the first material may be a fire-resistant filler.

In an embodiment of the present disclosure, the first plate and the second plate may be formed of second material that is fire-resistant.

In an embodiment of the present disclosure, the melting point of the second material may be higher than the melting point of the first material.

In an embodiment of the present disclosure, the second material may be mica.

In another embodiment of the present disclosure, a battery assembly may include: a plurality of battery cells arranged in a stacked configuration; an accommodation case accommodating the plurality of battery cells; an insertion space formed between the plurality of battery cells and the accommodation case; and a fire-resistant assembly inserted into the insertion space.

In another embodiment of the present disclosure, the battery assembly may further include: a busbar accommodated in the accommodation case and electrically connected to respective lead tabs of the plurality of battery cells; and a busbar frame on which the busbar is mounted.

In another embodiment of the present disclosure, the insertion space may be formed among a body portion of the battery cell, respective lead tabs, and a busbar.

According to an embodiment of the present disclosure, thermal propagation during thermal runaway of a battery cell can be suppressed.

According to another embodiment of the present disclosure, arrangement of a fire-resistant assembly during assembly of a battery assembly can be facilitated.

According to another embodiment of the present disclosure, the stability of a battery assembly can be enhanced by increasing the heat resistance or fire resistance of the battery assembly.

According to another embodiment of the present disclosure, process efficiency in the manufacturing process of a battery assembly can be improved.

### BRIEF DESCRIPTION OF THE DRAWINGS

FIG. 1 is a perspective view schematically illustrating a battery assembly according to an embodiment of the present disclosure.

FIG. 2 is an exploded perspective view schematically illustrating a battery assembly according to an embodiment of the present disclosure in a disassembled state.

FIG. 3 is a schematic diagram schematically illustrating a battery assembly according to an embodiment of the present disclosure as viewed from above.

FIG. 4 is a schematic diagram schematically illustrating an enlarged view of a portion S1 of FIG. 3.

FIG. 5 schematically illustrates a fire-resistant assembly accommodated in an insertion space according to an embodiment of the present disclosure.

FIG. 6 is a perspective view schematically illustrating a fire-resistant assembly according to an embodiment of the present disclosure.

FIG. 7 is a schematic diagram schematically illustrating a first plate and a second plate being assembled by intersecting with each other according to an embodiment of the present disclosure.

FIG. 8 is a schematic diagram schematically illustrating a support structure formed by a first plate and a second plate intersecting with each other according to an embodiment of the present disclosure.

FIG. 9 is a schematic diagram schematically illustrating a first plate and a second plate forming a first intersection angle and a second intersection angle by intersecting with each other according to an embodiment of the present disclosure.

FIGS. 10A and 10B are schematic diagrams schematically illustrating heat being transferred to a fire-resistant assembly and a first plate and a second plate being pivotally rotated relative to each other during a thermal runaway situation of a battery assembly according to an embodiment of the present disclosure.

FIG. 11 is a schematic diagram schematically illustrating a manufacturing process of a fire-resistant assembly in sequential order according to an embodiment of the present disclosure.

FIG. 12 is a schematic diagram schematically illustrating a modified shape of a fire-resistant assembly according to another embodiment of the present disclosure.

### DETAILED DESCRIPTION

Hereinbelow, embodiments of the present application are described in detail with reference to the accompanying drawings so that those of ordinary skill in the art to which the present application pertains can easily practice the present application. However, the present application may be implemented in various different forms and is not limited to the embodiments described herein. In addition, parts that are irrelevant to the description are omitted in the drawings to clearly describe the present application, and similar reference numerals are assigned to similar parts throughout the specification.

In the present disclosure, "secondary battery" refers to a battery cell, and may have an electrode assembly structure in which a positive electrode plate/separator/negative electrode plate structure is stacked in a laminate sheet exterior material, and the electrode assembly may be enclosed in a state connected to electrodes formed on the exterior of the electrode assembly. In addition, the electrodes may extend to the outside of the sheet in the same direction or in opposite directions.

Additionally, in the present disclosure, the secondary battery includes all of secondary batteries, battery cells, and batteries.

Additionally, in the present disclosure, a battery cell refers to a basic unit of a lithium secondary battery, specifically a lithium-ion battery, that can charge and discharge electrical energy. For example, main components of a battery cell include a cathode electrode, an anode electrode, a separator, and an electrolyte, and the main components may be included in a case (or a pouch).

Additionally, in the present disclosure, a battery module refers to a battery assembly in which one or more of the above-described battery cells are bundled together and placed in a case to protect the battery cells from external impacts, such as vibration, heat, and the like. One or more of such battery cells can supply electricity to the outside or receive electricity from the outside through a busbar assembly including a busbar and a busbar frame electrically connected to each other.

Additionally, a battery pack may refer to a single set in which a predetermined quantity of battery modules are gathered and electrically connected to achieve a finally desired voltage or power.

To describe the present disclosure, the following description is based on a spatial Cartesian coordinate system defined by mutually orthogonal X-axis, Y-axis, and Z-axis. Unless otherwise specified, the Z-direction refers to a height direction, and the X-direction (or a first direction) refers to any one direction among directions perpendicular to the height direction. And the Y-direction (or a second direction) refers to a direction perpendicular to the Z-direction and the X-direction.

However, the X-direction, Y-direction, and Z-direction mentioned below are for the purpose of clearly describing the present disclosure, and the respective directions may be defined differently depending on where the reference point is set.

The use of ordinal prefixes such as "first," "second," "third," and the like before components mentioned below is merely for avoiding confusion of the components being referred to, and is not related to the order, importance, or hierarchical relationship among the components.

As used in the present specification, the singular form may include the plural form unless the context clearly indicates otherwise.

Hereinbelow, the fire-resistant assembly 300 according to various embodiments of the present disclosure will be described in more detail through the following drawings.

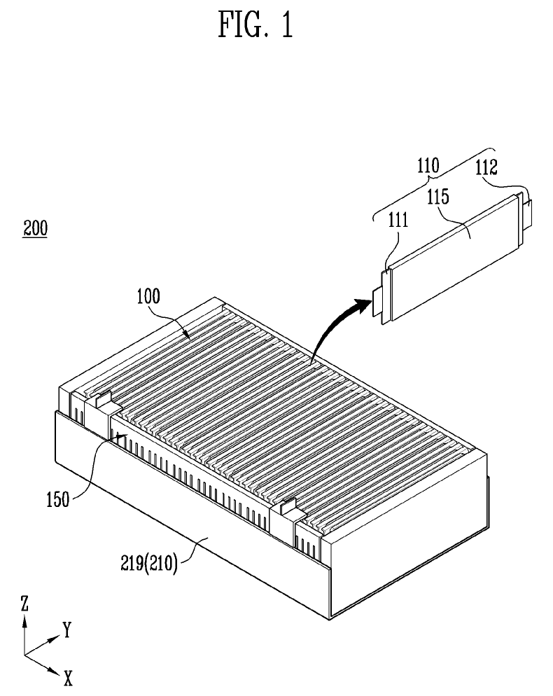

FIG. 1 is a perspective view schematically illustrating a battery assembly 200 according to an embodiment of the present disclosure.

For example, the battery assembly 200 may include a plurality of battery cells 110 and an accommodation case 210 accommodating the plurality of battery cells 110. Additionally, each of the plurality of battery cells 110 may include a body portion 115 that generates or stores electrical energy, and lead tab portions 111 and 112 protruding outward from the body portion 115. Additionally, the body portion 115 may include an electrode assembly (not shown) therein including a positive electrode and a negative electrode for generating and storing electrical energy.

Additionally, the body portion 115 may further include an electrolyte (not shown) in contact with the electrode assembly. For example, the electrolyte may be a liquid or a solid. Additionally, when the electrolyte is a liquid, the electrode assembly may further include a separator for separating the positive electrode and the negative electrode.

As shown in FIG. 1, the body portion 115 may be in a pouch form sealed with a film-type exterior material. In an embodiment of the present disclosure, a pouch-type battery cell 110 is described, but the present disclosure is not limited thereto. Accordingly, the present disclosure is also applicable to prismatic and cylindrical battery cells.

For example, the lead tab portions 111 and 112 may include a first lead tab portion 111 and a second lead tab portion 112, each protruding from respective sides of the body portion 115. Additionally, the lead tab portions 111 and 112 may both be provided on a single side.

As shown in FIG. 1, the accommodation case 210 according to an embodiment of the present disclosure may accommodate the plurality of battery cells 110 to protect the plurality of battery cells 110 from external impacts, such as vibration. Additionally, the accommodation case 210 may include an accommodation body 219 forming a part of an accommodation space 280 that accommodates the plurality of battery cells 110. Additionally, in an embodiment of the present disclosure, the plurality of battery cells 110 may be stacked and arranged in a predetermined stacking direction and accommodated in the accommodation case 210, and a fire-resistant assembly 300, which will be described later, may be inserted into an insertion space formed between the plurality of battery cells 110 and the accommodation case 210.

Additionally, the battery assembly 200 may further include a busbar assembly 150 electrically connecting the plurality of battery cells 110 to the outside. The busbar assembly 150 may include a busbar 170 electrically connecting the plurality of battery cells 110 so that a preset voltage is output. A configuration in which the busbar assembly 150 or the busbar 170 is assembled with the plurality of battery cells 110 may be referred to as a cell stack 100 of the battery cells 110.

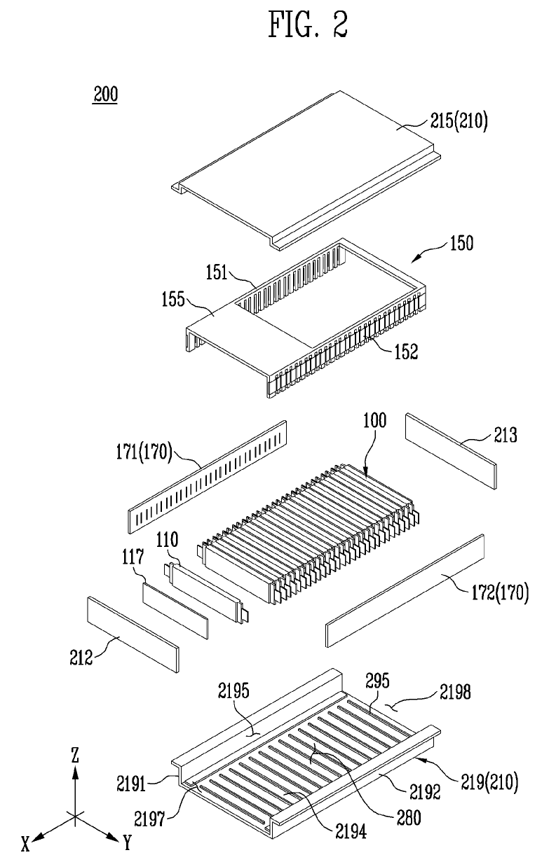

FIG. 2 is an exploded perspective view schematically illustrating a battery assembly 200 according to an embodiment of the present disclosure in a disassembled state.

As shown in FIG. 2, the accommodation case 210 may include an accommodation body 219 forming a part of an accommodation space 280 that accommodates the plurality of battery cells 110, and an accommodation cover 215 coupled to the accommodation body 219 to together form the accommodation space 280.

Additionally, the plurality of battery cells 110 may be overlapped along the X-direction inside the accommodation body 219. For example, the accommodation case 210 may include an open upper surface 2195, and further include an accommodation body 219 that accommodates the plurality of battery cells 110 through the open upper surface 2195, and an accommodation cover 215 coupled to the accommodation body 219 to cover the open upper surface 2195. Accordingly, the accommodation cover 215 may be coupled to the accommodation body 219 to form an upper surface of the accommodation space 280 or an upper surface of the accommodation case 210.

Meanwhile, the accommodation space 280 may include a space formed inside the accommodation body 219 for accommodating the cell stack 100. Additionally, the accommodation space 280 may further include an insertion space 288, which will be described later.

As shown in FIG. 2, the accommodation body 219 may be provided in a channel shape or a U-shape with an open upper portion. Referring to FIG. 2, both side surfaces 2197 and 2198 of the accommodation body 219, which face each other along the X-direction, may be open. That is, the accommodation body 219 may include a body bottom surface 2194 forming a bottom surface of the accommodation space 280, and body side surfaces 2191 and 2192 extending from edges (not shown) arranged in parallel along the stacking direction among edges of the body bottom surface 2194, toward the accommodation cover 215. Additionally, free ends of the body side surfaces 2191 and 2192 may be bent to form flanges (not shown). This is for facilitating coupling between the accommodation cover 215 and the accommodation body 219.

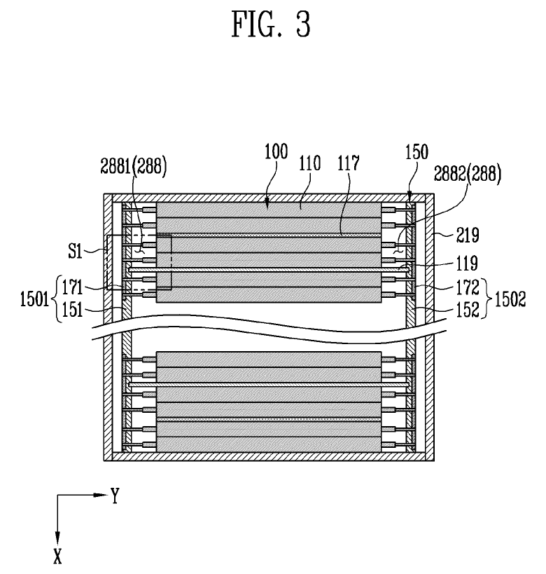

For example, the cell stack 100 may further include a buffer member 117 or a thermal barrier member 119 (see FIG. 3) positioned between the plurality of battery cells 110. For example, the buffer member 117 or the thermal barrier member 119 may be positioned between every battery cell 110, or may be positioned between battery groups in which the plurality of battery cells 110 are grouped.

For example, the thermal barrier member 119 may serve as a thermal barrier for preventing flames or heat from propagating to another adjacent battery cell 110 during thermal runaway of any one of the battery cells 110.

For example, the cell stack 100 may include one or more of the buffer member 117 or the thermal barrier member 119. Additionally, the buffer member 117 and the thermal barrier member 119 may be formed as a single member to simultaneously perform a thermal barrier function and a buffer function. For example, the thermal barrier member 119 may be formed in a multilayer structure along the stacking direction of the plurality of battery cells 110. That is, one layer among the multilayer structure may be formed of a flame-retardant material (or a fire-resistant material). Additionally, another layer among the multilayer structure may perform a role of reducing pressure exerted on other battery cells 110 during swelling of any given battery cell 110.

Additionally, the plurality of battery cells 110 and the plurality of buffer members 117 or thermal barrier members 119 may be provided at predetermined positions and stacked. For example, the plurality of battery cells 110 may be provided such that their long edges are parallel to the Y-direction, and accordingly, the plurality of battery cells 110 and the plurality of buffer members 117 or thermal barrier members 119 may be positioned overlapping in the X-direction.

For example, the thermal barrier member 119 may be formed of a fire-resistant (heat resistant or flame retardant) material. For example, the thermal barrier member 119 may include a material, such as a fire-resistant polymer or mica.

As shown in FIG. 2, the battery assembly 200 may further include end plates 212 and 213 at both ends of the cell stack 100 along the stacking direction. The end plates 212 and 213 may be provided at both ends of the cell stack 100, or may be formed by being connected to both side surfaces 2197 and 2198 of the accommodation body 219. For example, the end plates 212 and 213 may prevent both sides of the cell stack 100 from being exposed to the outside.

For example, the battery assembly 200 may include a busbar 170 electrically connected to the plurality of battery cells 110. Additionally, the battery assembly 200 may further include busbar frames 151, 152, and 155 supporting the busbar 170 and the plurality of battery cells 110. The busbar 170 and the busbar frames 151, 152, and 155 may be combined and referred to as a busbar assembly 150. For example, the busbar assembly 150 may be electrically connected to the outside to store or charge electrical energy in the plurality of battery cells 110, or to supply or discharge electrical energy stored in the plurality of battery cells 110 to the outside.

For example, the busbar assembly 150 may include a first busbar frame 151 and a second busbar frame 152 extending along the stacking direction of the plurality of battery cells 110 with the plurality of battery cells 110 interposed therebetween. Additionally, the busbar assembly 150 may further include a support frame 155 positioned at one side of the busbar assembly 150 and connecting the first busbar frame 151 and the second busbar frame 152.

Meanwhile, when the lead tab portions 111 and 112 are positioned at one side of the body portion 115 and face in the same direction, the busbar frames 151 and 152 may be positioned at one side of the body portion 115, for example, above the body portion 115, and may be electrically connected to the lead tab portions 111 and 112.

For example, the battery assembly 200 according to an embodiment of the present disclosure may further include a support frame 155 capable of supporting the first busbar frame 151 and the second busbar frame 152 while preventing deformation thereof. Additionally, the support frame 155 may be connected to the first busbar frame 151 and the second busbar frame 152 to cover the upper portion of the plurality of battery cells 110. That is, the support frame 155 may cover not only a part of the upper portion of the plurality of battery cells 110, but also the entirety thereof.

Additionally, a part of an electrical device for sensing and controlling the plurality of battery cells 110 may be disposed on the support frame 155.

In FIG. 2, the busbar 170 may include a first busbar 171 mounted on the first busbar frame 151 and electrically connected to the first lead tab portion 111, and a second busbar 172 mounted on the second busbar frame 152 and electrically connected to the second lead tab portion 112. Additionally, the first lead tab portion 111 and the second lead tab portion 112 may be inserted into slit holes (not shown) formed in the first busbar frame 151 and the second busbar frame 152, respectively, and electrically connected to the first busbar 171 and the second busbar 172.

For example, the battery assembly 200 according to an embodiment of the present disclosure may further include a heat dissipation portion 295 positioned between the body bottom surface 2194 and the plurality of battery cells 110, configured to transfer heat generated from the plurality of battery cells 110 to the outside of the battery assembly 200. For example, the heat dissipation portion 295 may be provided as an adhesive material having thermal conductivity that can be sprayed or applied on the body bottom surface 2194. Accordingly, the plurality of battery cells 110 may be adhered to the body bottom surface 2194 through the heat dissipation portion 295.

FIG. 3 is a schematic diagram schematically illustrating a battery assembly as viewed from above according to an embodiment of the present disclosure.

As shown in FIG. 3, the busbar assembly 150 may include a first busbar 171 electrically connected to the first lead tab portion 111, and a first busbar frame 151 on which the first busbar 171 is mounted. The first busbar 171 and the first busbar frame 151 may be collectively referred to as a first busbar assembly 1501. Additionally, the busbar assembly 150 may include a second busbar 172 electrically connected to the second lead tab portion 112, and a second busbar frame 152 on which the second busbar 172 is mounted. The second busbar 172 and the second busbar frame 152 may be collectively referred to as a second busbar assembly 1502.

In an embodiment of the present disclosure, the insertion space 288 in which the fire-resistant assembly 300 is inserted may be a space formed among a body portion 115 of the battery cell 110, respective lead tab portions 111 and 112, and a first busbar 171 or a second busbar 172.

For example, as shown in FIG. 3, due to the electrical connection between the lead tab portions 111 and 112 and the busbar assembly 150, an empty space (hereinafter referred to as an insertion space 288) may be formed between the plurality of battery cells 110 and the busbar assembly 150. That is, the insertion space 288 may be formed by each body portion 115, each lead tab portion 111 and 112, and the busbar 170.

For example, when thermal runaway occurs in any one of the plurality of battery cells 110 and off-gas is generated, high-temperature heat may propagate to another adjacent battery cell through the insertion space 288. Accordingly, to prevent thermal propagation to another adjacent battery cell, the insertion space 288 needs to be filled or plugged using a fire-resistant assembly 300, which will be described later.

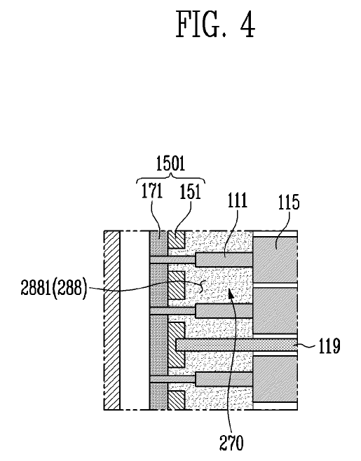

FIG. 4 is a schematic diagram schematically illustrating an enlarged view of a portion S1 of FIG. 3.

As shown in FIGS. 3 and 4, the battery assembly 200 may include a first insertion space 2881 formed between one side surface of each body portion 115 of the battery cell 110 and the first busbar 171, and a second insertion space 2882 formed between the other side surface of each body portion 115 of the battery cell 110 and the second busbar 172.

For example, the fire-resistant assembly 300 according to an embodiment of the present disclosure may be positioned in at least one of the first insertion space 2881 or the second insertion space 2882.

Additionally, since the height of the first lead tab portion 111 and the second lead tab portion 112 along the height direction of the accommodation case 210 or the accommodation body 219 is smaller than the height of the battery cell 110, the first insertion space 2881 and the second insertion space 2882 may be in communication with each other.

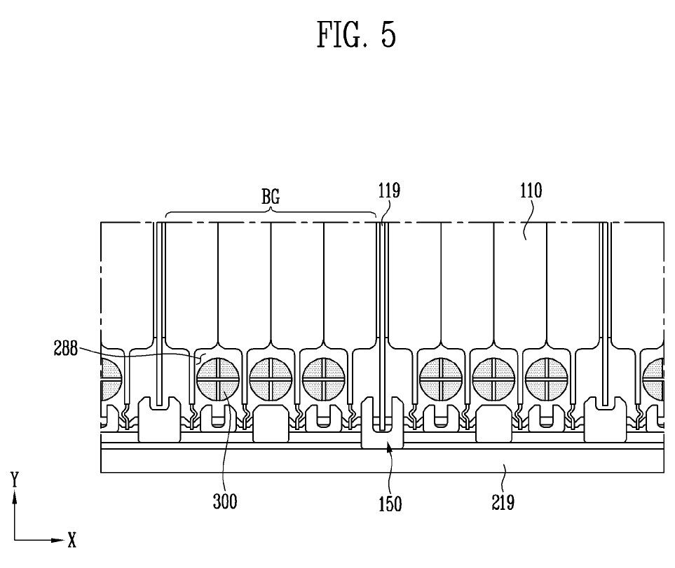

FIG. 5 schematically illustrates a fire-resistant assembly 300 accommodated in an insertion space according to an embodiment of the present disclosure.

As shown in FIG. 5, a plurality of fire-resistant assemblies 300 may be respectively inserted into a plurality of insertion spaces 288 formed between the plurality of battery cells 110 and the busbar assembly 150.

Meanwhile, as shown in FIG. 5, the thermal barrier member 119 positioned between the plurality of battery cells 110 may be provided in parallel with the plurality of battery cells 110 and may also extend to the busbar assembly 150. More specifically, the thermal barrier member 119 may extend to the busbar frames 151 and 152 and be inserted into grooves formed in the busbar frames 151 and 152. In this case, to prevent interference between the fire-resistant assembly 300 and the thermal barrier member 119, the fire-resistant assembly 300 may not be inserted into the space where the thermal barrier member 119 is inserted.

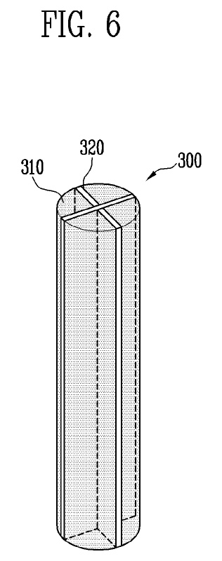

FIG. 6 is a perspective view schematically illustrating a fire-resistant assembly 300 according to an embodiment of the present disclosure.

In an embodiment of the present disclosure, the fire-resistant assembly 300 may include a fire-resistant portion 310 including first material that is fire-resistant, and a support structure embedded inside the fire-resistant portion 310.

As shown in FIG. 6, the fire-resistant assembly 300 according to an embodiment of the present disclosure may have a cylindrical shape. For example, considering the size of the above-described insertion space 288, a diameter of the fire-resistant assembly 300 may be smaller than a thickness of any one of the battery cells. Accordingly, the fire-resistant assembly 300 can be easily inserted into the insertion space 288.

Additionally, both ends of the cylindrical fire-resistant assembly 300 may further include a tapered shape (not shown). Thereby, the fire-resistant assembly 300 can be more easily inserted into the insertion space 288.

Additionally, both ends of the fire-resistant assembly 300 according to an embodiment of the present disclosure may have a symmetrical shape. Thereby, the fire-resistant assembly 300 can be inserted into the insertion space 288 without distinguishing between the top and the bottom, and the convenience of assembling the battery assembly 200 can be increased.

As shown in FIG. 6, in the fire-resistant assembly 300 according to an embodiment of the present disclosure, the support structure is disposed at the center thereof, and the fire-resistant portion 310 surrounds the support structure 320, such that the support structure 320 is embedded inside the fire-resistant portion 310.

For example, the fire-resistant portion 310 may include a filler of a first material having heat resistant, fire-resistant, and/or flame retardant properties. For example, the first material may be a fire-resistant filler. Accordingly, heat transfer between adjacent battery cells due to gas generated during thermal runaway can be minimized, so that thermal propagation between the battery cells can be delayed.

Meanwhile, the fire-resistant portion 310 may be a composite material including a plurality of materials rather than a single material. Some materials may satisfy heat resistance, some materials may satisfy fire resistance, and some materials may be provided for flame retardancy. Rather than a plurality of materials being mixed and provided as a single integrated form, the plurality of materials may also be separated and stacked.

For example, the fire-resistant portion 310 may include a material that is cured into a solid state after being injected in a liquid state. For example, the material of the first material that can be cured from a liquid state to a solid state may include one or more of acrylic-based resin, epoxy-based resin, olefin-based resin, urethane-based resin, ethylene vinyl acetate (EVA)-based resin, or silicone-based resin.

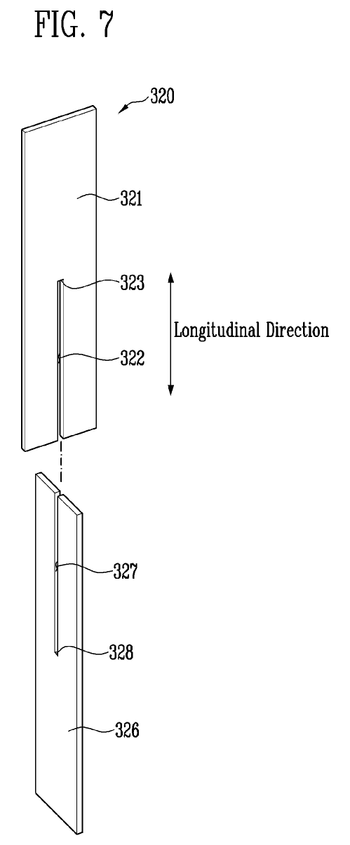

FIG. 7 is a schematic diagram schematically illustrating a first plate 321 and a second plate 326 being assembled into a support structure 320 by intersecting with each other according to an embodiment of the present disclosure.

In an embodiment of the present disclosure, the support structure 320 may include a first plate 321 and a second plate 326, and the first plate 321 and the second plate 326 may intersect with each other.

Additionally, in an embodiment of the present disclosure, the first plate 321 may include a first slit 322 in which a first opening is formed in the longitudinal direction of the support structure 320, and a first fixed end at which the first opening terminates, and the second plate 326 may include a second slit 327 in which a second opening is formed in the longitudinal direction of the support structure 320, and a second fixed end 328 at which the second opening terminates.

For example, as shown in FIG. 7, the first plate 321 may include a first slit 322 in which a first opening is formed in the longitudinal direction of the support structure 320. Additionally, the second plate 326 may include a second slit 327 in which a second opening is formed in the longitudinal direction of the support structure 320. Additionally, a first fixed end 323 may be formed at a terminal end of the first slit 322 where the first opening of the first plate 321 terminates, and a second fixed end 328 may be formed at a terminal end of the second slit 327 where the second opening of the second plate 326 terminates.

In an embodiment of the present disclosure, the first plate 321 and the second plate 326 may be formed of second material that is fire-resistant, and the second material may have a melting point higher than the melting point of the first material corresponding to the material of the above-described fire-resistant portion 310.

For example, the first plate 321 and the second plate 326 may be configured to block heat or flames generated from a battery cell. Accordingly, the first plate 321 and the second plate 326 may include a material having one or more properties among flame retardancy, heat resistance, fire resistance, and thermal insulation. For example, heat resistance or fire resistance refers to a property of not melting and not changing in shape even at a temperature of 1,000° C. or higher, and the second material forming the first plate 321 and the second plate 326 may have a melting point higher than the melting point of the above-described fire-resistant portion 310.

For example, the second material constituting the first plate 321 and the second plate 326 may include one or more of mica, silicate, graphite, alumina, and ceramic wool (or super wool), and may be formed of any material that can maintain the shape thereof during a thermal runaway situation of a battery cell and can prevent heat or flames from propagating to adjacent battery cells.

Meanwhile, the second material constituting the first plate 321 and the second plate 326 may use the same material selected from among the above-described exemplary materials of the second material, or may use different materials respectively selected from among the above-described exemplary materials of the second material.

For example, when the second material constituting the first plate 321 and the second plate 326 is formed of the same mica, the melting point of mica is 1,300° C. to 1,400° C., which is about 300° C. higher than the melting point of ceramic wool. Accordingly, considering that the internal temperature during a thermal runaway situation of a battery cell is about 1,100° C., the first plate 321 and the second plate 326 can maintain their heat resistance or fire resistance performance and maintain their shape even during a thermal runaway situation of the battery cell.

For example, when the fire-resistant assembly 300 does not use the support structure 320 and is composed only of the above-described first material, the melting point is low, and thus a sufficient thermal propagation suppression effect cannot be expected during a battery thermal runaway situation. Accordingly, by introducing the support structure 320 formed of the first plate 321 and the second plate 326 made of mica into the fire-resistant assembly 300, the thermal propagation suppression effect can be improved during a battery thermal runaway situation.

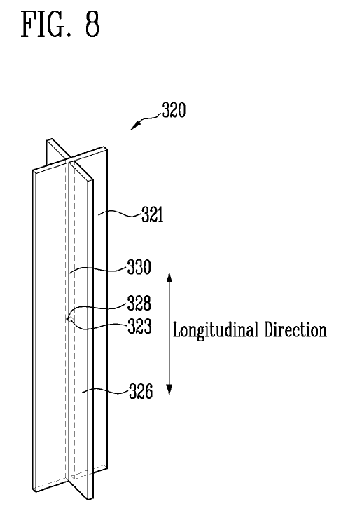

FIG. 8 is a schematic diagram schematically illustrating a support structure 320 formed by a first plate 321 and a second plate 326 intersecting with each other according to an embodiment of the present disclosure.

In an embodiment of the present disclosure, the support structure 320 may be assembled by inserting the first slit 322 of the first plate 321 and the second slit 327 of the second plate 326 into each other in the longitudinal direction, and may form an intersection portion 330 where the first plate 321 and the second plate 326 intersect. Additionally, in an embodiment of the present disclosure, the support structure 320 may be formed by the first fixed end 323 and the second fixed end 328 being in contact with each other.

For example, as shown in FIGS. 7 and 8, the support structure 320 may be assembled by inserting the first slit 322 of the first plate 321 and the second slit 327 of the second plate 326 into each other in the longitudinal direction. The relative movement of the first plate 321 and the second plate 326 may terminate as the first fixed end 323 of the first plate 321 and the second fixed end 328 of the second plate 326 come into contact with each other.

For example, in a state where the first fixed end 323 of the first plate 321 and the second fixed end 328 of the second plate 326 face and are in contact with each other, a linear intersection portion 330 may be formed at the portion where the first plate 321 and the second plate 326 intersect.

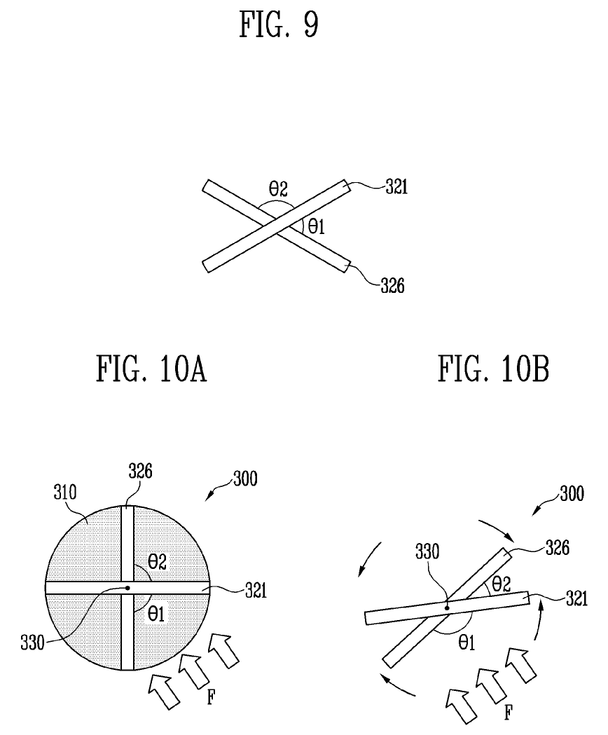

FIG. 9 is a schematic diagram schematically illustrating a first plate 321 and a second plate 326 forming a first intersection angle θ1 and a second intersection angle θ2 by intersecting with each other according to an embodiment of the present disclosure.

In an embodiment of the present disclosure, the support structure 320 may include a first intersection angle θ1 and a second intersection angle θ2 formed by the first plate 321 and the second plate 326 intersecting with each other.

Additionally, in an embodiment of the present disclosure, the first intersection angle θ1 and the second intersection angle θ2 may be formed to be equal to each other, and for example, the first intersection angle θ1 and the second intersection angle θ2 may be formed to be different from each other, such that the first intersection angle θ1 is smaller than the second intersection angle θ2.

As shown in FIG. 9, as the first plate 321 and the second plate 326 intersect, a first intersection angle θ1 and a second intersection angle θ2 may be formed between the first plate 321 and the second plate 326 relative to each other with the intersection portion 330 as the center. For example, the first intersection angle θ1 may be an angle at which the first plate 321 is inclined with respect to the second plate 326, and the second intersection angle θ2 may be an angle at which the second plate 326 is inclined with respect to the first plate 321.

Arithmetically, a sum of the first intersection angle θ1 and the second intersection angle θ2 may be 180°, and for example, when the first intersection angle θ1 and the second intersection angle θ2 are equal in magnitude, the first intersection angle θ1 and the second intersection angle θ2 may each be 90°. For example, in the embodiment shown in FIG. 9, the first intersection angle θ1 is set to be smaller than the second intersection angle θ2.

FIGS. 10A and 10B are schematic diagrams schematically illustrating heat F being transferred to a fire-resistant assembly 300 and a first plate 321 and a second plate 326 being pivotally rotated relative to each other during a thermal runaway situation of a battery assembly according to an embodiment of the present disclosure.

In an embodiment of the present disclosure, during thermal runaway of the battery assembly, the first plate 321 is pivotally rotatable with respect to the second plate 326 about the intersection portion 330. Additionally, during thermal runaway of the battery, the magnitudes of the first intersection angle θ1 and the second intersection angle θ2 are variable, and for example, the first intersection angle θ1 may increase and the second intersection angle θ2 may decrease.

As shown in FIG. 10A, during a thermal runaway situation of the battery, heat F may be assumed to be transferred from the lower right side. Meanwhile, the direction of heat F transfer shown in FIGS. 10A and 10B are illustrative, and the direction may change depending on the thermal runaway situation of any given battery cell.

For example, during the initial transfer of heat F, the fire-resistant portion 310 and the support structure 320 may simultaneously resist heat to suppress the propagation of heat F. However, when the thermal runaway situation does not end and heat F continues to be transferred, the fire-resistant assembly 300 according to an embodiment of the present disclosure may suppress the propagation of heat F, while over time, the fire-resistant portion 310 having a lower melting point than the support structure 320 may gradually melt. Accordingly, only the support structure 320 having a higher melting point than the fire-resistant portion 310 may remain without melting.

Meanwhile, as shown in FIG. 10B, due to convection of heat F, such as gas flow and flame flow from the direction in which heat F is applied, the first plate 321 and the second plate 326 of the support structure 320 may be pivotally rotated relative to each other about the intersection portion 330.

Accordingly, when the support structure 320 is formed with the first intersection angle θ1 and the second intersection angle θ2 being equal at 90° in FIG. 10A, during thermal runaway of the battery, due to the pivotal rotation of the first plate 321 and the second plate 326, the magnitudes of the first intersection angle θ1 and the second intersection angle θ2 may vary.

For example, in FIG. 10B, during thermal runaway of the battery, the first intersection angle θ1 increases and the second intersection angle θ2 decreases. As a result, the first plate 321 and the second plate 326 may be arranged to overlap each other with respect to the direction of heat F transfer, and the first plate 321 and the second plate 326 that do not melt can doubly suppress the transfer of heat F against convection during thermal runaway of the battery.

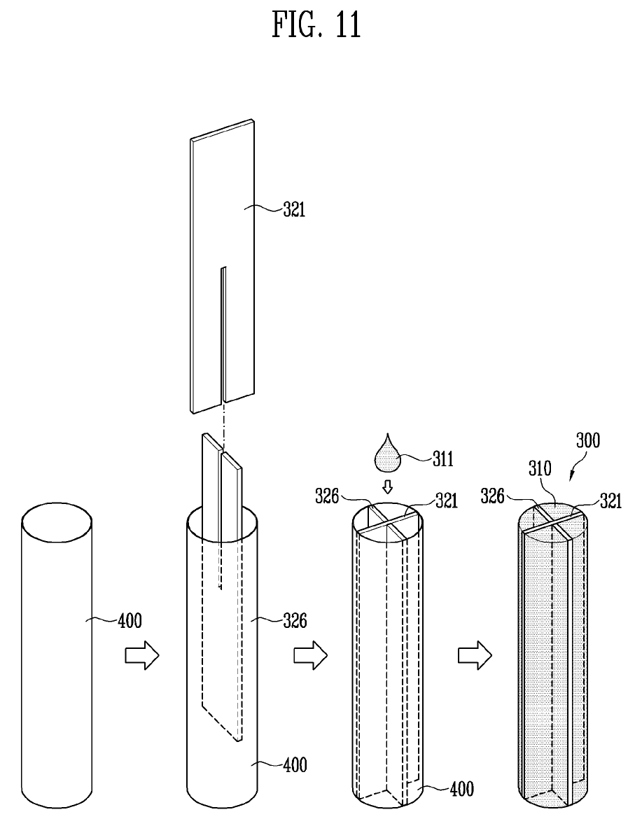

FIG. 11 is a schematic diagram schematically illustrating a manufacturing process of a fire-resistant assembly 300 in sequential order according to an embodiment of the present disclosure.

For example, as shown in FIG. 11, the fire-resistant assembly 300 according to an embodiment of the present disclosure may be manufactured by placing the second plate 326 and the first plate 321 in a mold 400, injecting first material 311 that is fire-resistant into the remaining space, and curing the first material 311.

For example, the first material 311 that is fire-resistant may be mixed with a binder. The binder may be a material that is cured while bonding particles of the first material 311 to each other. Alternatively, after mixing the first material 311 that is fire-resistant and a binder, the binder may be cured or foamed by a separate curing agent. For example, the curing agent may be cured by ultraviolet (UV) light, or cured over time upon mixing with the binder. For example, the material of the binder may be a polymer, such as a resin. Additionally, the binder may be a heat resistant or flame retardant material that does not melt up to an allowable temperature.

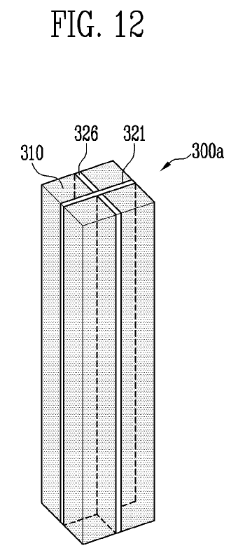

FIG. 12 is a schematic diagram schematically illustrating a modified shape of a fire-resistant assembly 300a according to another embodiment of the present disclosure.

As shown in FIG. 12, the fire-resistant assembly 300a according to another embodiment of the present disclosure may be manufactured in a rectangular column shape. Such a three-dimensional shape may be determined by the mold 400 shown in FIG. 11. As examples of three-dimensional shapes, a cylindrical shape and a rectangular column shape have been described, but a polyhedral shape may also be configured depending on the shape of the mold 400.

For example, the fire-resistant assemblies 300 and 300a illustrated in FIGS. 11 and 12 have flat surfaces at both end regions, but the shape of both end regions of the fire-resistant assemblies 300 and 300a may also be changed depending on the shape of the mold 400 prepared. For example, the shape of both end regions of the fire-resistant assemblies 300 and 300a may be manufactured to be identical to each other, or may be manufactured to be different from each other. For example, both end regions of the fire-resistant assemblies 300 and 300a may be formed in a tapered shape.

The scope of the present disclosure is defined by the appended claims rather than by the above detailed description, and all modifications or variations derived from the meaning and scope of the claims and their equivalents are to be construed as being included in the scope of the present disclosure.

What is claimed is:

1. A fire resistant assembly comprising:
a fire resistant portion including first material that is fire resistant; and
a support structure embedded inside the fire resistant portion.

2. The fire resistant assembly of claim 1, wherein the support structure comprises a first plate and a second plate.

3. The fire resistant assembly of claim 2, wherein the first plate and the second plate intersect with each other.

4. The fire resistant assembly of claim 3, wherein the first plate comprises a first slit in which a first opening is formed in a longitudinal direction of the support structure, and a first fixed end at which the first opening terminates, and
wherein the second plate comprises a second slit in which a second opening is formed in the longitudinal direction of the support structure, and a second fixed end at which the second opening terminates.

5. The fire resistant assembly of claim 4, wherein the support structure comprises an intersection portion formed by the first plate and the second plate intersecting with each other, by the first slit and the second slit being inserted into each other in the longitudinal direction.

6. The fire resistant assembly of claim 5, wherein the first fixed end and the second fixed end are in contact with each other.

7. The fire resistant assembly of claim 6, wherein the support structure comprises a first intersection angle and a second intersection angle formed by the first plate and the second plate intersecting with each other.

8. The fire resistant assembly of claim 7, wherein the first intersection angle is smaller than or equal to the second intersection angle.

9. The fire resistant assembly of claim 1, wherein the first material is a fire resistant filler.

10. The fire resistant assembly of claim 2, wherein the first plate and the second plate comprise second material that is fire resistant.

11. The fire resistant assembly of claim 10, wherein a melting point of the second material is higher than a melting point of the first material.

12. The fire resistant assembly of claim 11, wherein the second material is mica.

13. A battery assembly comprising:
a plurality of battery cells arranged in a stacked configuration;
an accommodation case accommodating the plurality of battery cells;
an insertion space formed between the plurality of battery cells and the accommodation case; and
the fire resistant assembly according to claim 1, the fire resistant assembly being inserted into the insertion space.

14. The battery assembly of claim 13, further comprising:
a busbar accommodated in the accommodation case and electrically connected to respective lead tab portions of the plurality of battery cells; and
a busbar frame on which the busbar is mounted.

15. The battery assembly of claim 14, wherein the insertion space is formed among a body portion of the battery cell, the respective lead tab portions, and the busbar.
